(19) United States
(12) Patent Application Publication
(10) Pub. No.: US 2013/0234848 A1
(43) Pub. Date: Sep. 12, 2013

(54) Method of controlling a hazard alert system and a hazard alert system itself

(71) Applicant: JOB LIZENZ GMBH & CO. KG, Ahrensburg (DE)

(72) Inventors: Gerhard Röpke, Lubeck (DE); Stefan Janus, Ahrensburg (DE)

(73) Assignee: Job Lizenz GmbH & Co. KG, Ahrensburg (DE)

(21) Appl. No.: 13/777,206

(22) Filed: Feb. 26, 2013

(30) Foreign Application Priority Data
Feb. 27, 2012 (DE) 102012003584.5

(51) Int. Cl. G08B 27/00

(52) U.S. Cl. CPC G08B 27/00
USPC 340/501

(57) ABSTRACT

The invention concerns a method of controlling a hazard alert system with a control device and multiple release mechanisms connected to the control device, wherein the release mechanisms are each connected to at least one alarm device. The initialisation step consists of identification data being assigned to the release mechanisms, and then a control signal is transmitted by the control device to activate or deactivate the alarm devices to all the release mechanisms, wherein the control signal transmits identification data from one or more release mechanisms, and the identification data transmitted by the control device is compared, by the release mechanisms, to the identification data assigned to them. If the release mechanisms determine that the identification data compared with one another matches, they send a control signal to activate or deactivate the alarm devices connected with them, so that the alarm devices are activated or deactivated synchronously. In addition, the invention relates to a corresponding hazard alert system.

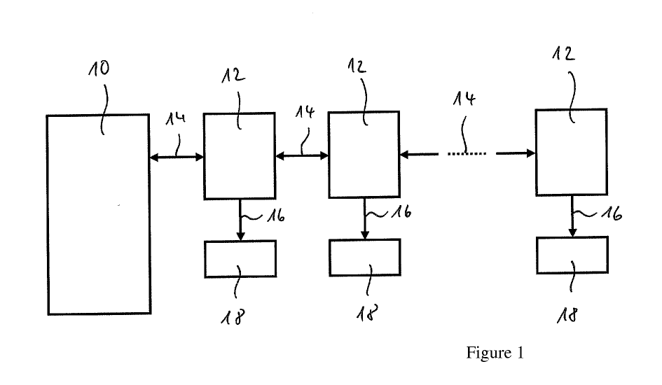

### CROSS-REFERENCE TO RELATED APPLICATIONS

Not applicable

### STATEMENT REGARDING FEDERALLY SPONSORED RESEARCH

Not applicable

### BACKGROUND OF THE INVENTION

The invention relates to a method of controlling a hazard alert system, as well as a hazard alert system itself Such hazard alert systems frequently include a fire alarm system control panel, to which a large number of hazard warning devices and alarm devices is connected. For example, in large office buildings, the individual hazard warning devices can then be monitored via the fire alarm system control panel. If a hazardous state is detected by one or more hazard warning devices, for example a fire, the fire alarm system control panel can activate one or all of the alarm devices, so that, for instance, the building can be evacuated. To ensure that such an evacuation is effected in an orderly manner, often several alarm devices are to be activated, which then emit, for example, their acoustic alarm signal, during overlapping periods of time. What is problematic, in that regard, is that signalling procedures that are superimposed upon one another and particular frequencies of acoustic signals may lead to a mixture of acoustic signals from different alarm devices, so that the original acoustic signal can no longer be identified or differentiated. Furthermore, it is often not desirable to activate all the alarm devices in such an extensive building simultaneously, as it is then no longer possible to evacuate the building in an orderly manner.

Taking the prior art explained as a starting point, the task forming the basis for the invention is to provide a method and a hazard alert system of the type mentioned at the beginning, wherein these are controlled in such a way that the building can be evacuated in a safe and orderly manner, and, in particular, acoustic signals can at any time be identified or differentiated from one another.

The invention solves this problem, as described below in the summary.

### BRIEF SUMMARY OF THE INVENTION

The invention firstly solves the problem by means of a method of controlling a hazard alert system that involves a control device and multiple release mechanisms connected to the control device, wherein the release mechanisms are each connected to at least one alarm device, comprising the following steps: the initialisation step consists of identification data being assigned to the release mechanisms, and then a control signal is transmitted by the control device to activate or deactivate the alarm devices on all the release mechanisms, wherein the control signal transmits identification data from one or more release mechanisms, and the identification data transmitted by the control device is compared, by the release mechanisms, to the identification data assigned to them. If the release mechanisms determine that the identification data compared with one another matches they send a control signal to activate or deactivate the alarm devices connected with them, so that the alarm devices to be activated or deactivated are activated or deactivated synchronously.

Secondly, the invention solves the problem through a hazard alert system with a control device and multiple release mechanisms connected to the control device via a control line, which, in turn, are each connected to at least one alarm device, wherein the release mechanisms each have a storage device, in which the identification data assigned to the respective release mechanisms is stored, wherein the control device features a transmitter, via which a control signal for activating or deactivating the alarm devices is transmitted to all the release mechanisms, wherein identification data of one or more release mechanisms can be transmitted with the control signal, and wherein the release mechanisms each have a comparing device, which is designed to compare the identification data sent out by the control device with the respective identification data deposited in the storage device, and wherein, if the identification data compared by the latter matches, the release mechanisms are designed to transmit a control signal to activate or deactivate the alarm devices to which they are connected, so that the alarm devices to be activated or deactivated are activated or deactivated synchronously.

According to the invention, a control device is connected via at least one cable, for example a so-called main fire detector line, with a large number of release mechanisms, which are, in turn, each connected to at least one alarm device. In that respect, the release mechanisms and alarm devices may also each form an integrated release and alarm device. Identification data, in particular communication addresses, is assigned to the respective release mechanisms. The release mechanisms are accessible via this identification data from the control device. The invention permits particular release mechanisms—and thus alarm devices13 to be targeted. For that purpose, the control device transmits a common command, in particular a so-called broadcasting command, to all the release mechanisms. The common command is independent of the identification data, and is received and processed by all the release mechanisms. With this common command, e.g. a command for activating the alarm devices, the control device also transmits one or more sets of identification data. Only those release mechanisms whose previously programmed identification data is transmitted with the common command do then actually execute the common command. Thus, the desired release mechanisms, and therefore alarm devices, can be specifically selected by selecting the identification data transmitted with the common command. In this way, it is possible to specifically target certain groups of release mechanisms or alarm devices, for example all alarm devices in a particular building, a particular wing of a building or a storey of a building. Thus, the storeys of a building can be evacuated, one by one, in a manner conducive to evacuating the building in an orderly manner, by an evacuation signal being transmitted via the alarm devices located on the storey in question. For this purpose, the release mechanisms each have at least one control output, which is activated when the identification data transmitted by the control device and that deposited in the release mechanism for triggering the respective alarm device match. A respective control input of the alarm devices connected to the respective release mechanisms is connected to the control output of the release mechanisms.

Moreover, the invention guarantees synchronous, i.e. simultaneous activation or deactivation of the respective selected alarm devices. Thus, the release command for activating or deactivating the alarm devices, is transmitted by the release mechanisms selected using the respective identification data virtually simultaneously with the respective alarm devices connected to such release mechanisms. Simultaneously or synchronously setting off the alarm devices, in particular acoustic alarm devices such as sirens, has the advantage that the course of the acoustic signal in the building can at any time still be perceived, without a mixture of acoustic signals from all the alarm devices occurring and it no longer being possible to differentiate the actual acoustic signal. Therefore the invention guarantees that, in the event of a fire, the building can be evacuated in an orderly manner.

According to one embodiment, the control signal for activating or deactivating the alarm devices can be transmitted by the control device to all the release mechanisms periodically. In order to avoid the release mechanisms and alarm devices being (permanently) activated, for example due to a malfunction, it may be provided for that the release mechanisms and, if applicable, the alarm devices, automatically switch off after a certain deactivation period, e.g. a few seconds. As long as an alarm is desired, with this embodiment activation impulses are therefore transmitted by the control device to the release mechanisms at sufficiently short intervals (less than the deactivation period), so that the alarm devices remain active.

According to another embodiment, the control signal for activating or deactivating the alarm devices may be transmitted to the release mechanisms by the control device as long as at least one release mechanism has previously transmitted a danger signal to the control device. Signals, in particular commands and data, can be bidirectionally exchanged via the connection between the control device and the release mechanisms. In particular, besides the control signals transmitted to the release mechanisms by the control device, hazard warning signals, for example, may also be transmitted to the control device by the release mechanisms, for instance if a state of danger, such as a fire, is detected by one or more release mechanisms. With this embodiment, if a fire is detected in a room of a building, an alarm signal may be triggered in the entire wing or on the entire storey of the building in which the room is located. It is also possible for the control device to transmit the identification data of at least the release mechanisms which have previously sent out a danger signal to the control device when the control signal for activating or deactivating the alarm devices is emitted.

According to a further embodiment, a communication address uniquely identifying each of the respective release mechanisms can be assigned to the release mechanisms as identification data. In the case of this embodiment, each release mechanism is assigned an individual communication address, so that all the release mechanisms can be addressed individually. Alternatively, it is also possible to form multiple groups of release mechanisms, wherein the release mechanisms in a group are assigned a common communication address as identification data. With this embodiment, the release mechanisms in different groups can be individually addressed, wherein the respective release mechanisms in a group can (only) be addressed jointly. For instance, in that regard, the release mechanisms may be grouped according to the storeys of a building.

The release mechanisms may be connected to a control line of the control device serially. Thus, there will be serial communication between the control device and the release mechanisms. Moreover, the release mechanisms may also be supplied with power via the control line. Thus, the control line between the control device and the release mechanisms, for example a main fire detector line, may have at least two leads, wherein one serves the purpose of communication between the control device and the release mechanisms, in particular for transmitting the control signals, and the other supplies the release mechanisms and/or the alarm devices with power.

The alarm devices may be hazard warning devices. In particular, the hazard warning devices may be fire alarms, e.g. smoke detectors. The alarm devices may be visual and/or acoustic alarm devices. The control device may be a fire alarm system control panel.

The device according to the invention may be designed to carry out the method according to the invention. Accordingly, the method according to the invention may be carried out by the device according to the invention.

### BRIEF DESCRIPTION OF THE DRAWING

An embodiment of the invention is explained in more detail below, using a drawing. The only FIGURE schematically shows a hazard alert system designed according to the invention.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated.

The hazard alert system according to the invention features a control device 10, in the present example a fire alarm system control panel 10. The hazard alert system moreover includes a large number of release mechanisms 12, in the present example, hazard warning devices 12, for instance fire alarms. The fire alarms 12 are connected in series with the fire alarm system control panel 10 via a control line 14—in the present case, a so-called main fire detector line. Via the main fire detector line 14, firstly signals are exchanged bidirectionally between the fire alarm system control panel 10 and the hazard warning devices 12. Furthermore, electric power is also supplied to the hazard warning devices 12 via the main fire detector line 14. The hazard warning devices 12 are, moreover, in the embodiment shown, each connected to an alarm device 18, being in the case of the embodiment shown an acoustic alarm device 18, such as a siren, via a connecting cable 16. In addition, the alarm devices 18 may also comprise visual alarm devices, such as flashlights.

During operation, as an initialisation step first of all identification data, in particular communication addresses, is assigned to the hazard warning devices 12, based on which the latter can be identified by the fire alarm system control panel 10. For example, the hazard warning devices 12 can be divided into multiple groups along with the alarm devices 18 assigned to them, wherein the same communication address is assigned to the respective hazard warning devices 12 in a group. The hazard warning devices 12 and alarm devices 18 may also be divided into groups according to the storeys of a building equipped with the hazard alert system. The hazard warning devices 12 each include a storage device, in which the communication addresses are stored.

Should, for example, one or more hazard warning device(s) 12 detect a state of danger when in operation, a corresponding danger signal can be transmitted to a transceiver of the fire alarm system control panel 10 via a transceiver of the hazard warning device(s). In so far as it is, for example, decided in the fire alarm system control panel 10 that the building is to be evacuated, the hazard warning devices 12 may be caused by the fire alarm system control panel 10 to activate the respective alarm devices 18 assigned to them. For this purpose, initially a common command, in particular a so-called broadcasting command, is transmitted by the fire alarm system control panel 10 via its transceiver, to all the hazard warning devices 12 to activate the alarm devices 18. This common command is received by all the hazard warning devices 12 via the transceivers. With the common command, initially, for example, the identification data of a first group of hazard warning devices 12 is transmitted by the fire alarm system control panel 10. The hazard warning devices 12 each include a comparing device, by means of which the identification data transmitted by the fire alarm system control panel 10 is compared with the identification data stored in the storage device of the respective hazard warning device 12. In that regard, should the comparing device determine a match, a control output of the corresponding hazard warning device 12 is activated and an activation signal transmitted to a control input of the corresponding alarm devices 18 via the connecting cables 16. This, in turn, leads to the corresponding alarm devices 18 being triggered.

Once the alarm devices 18 in this first group of hazard warning devices 12 have been activated for a certain period of time, the hazard warning devices 12 in a second and subsequent further groups can accordingly be controlled, so that these hazard warning devices 12 also successively activate their alarm devices 18. In the same way as described above concerning activation, in that respect the alarm devices 18 in the respective previous groups can be deactivated again, so that there is always only the one group of alarm devices 18 activated. In this way, an office building with many storeys may, for example, have its storeys evacuated successively, in an orderly manner.

Furthermore, the addressing of the hazard warning devices 12 according to the invention leads to the alarm devices 18 being activated by the respective hazard warning devices 12 addressed virtually simultaneously. In the case of the acoustic alarm devices 18 activated, it is ensured in this way that the respective alarm signal, for instance an acoustic evacuation signal, can still be clearly identified at any time. In particular, acoustic signals of various different alarm devices being superimposed upon one another, possibly leading to the acoustic signal no longer being clearly identifiable, is safely avoided.

It may, moreover, be provided for that the alarm devices 18 are each automatically deactivated again after a specified alarm duration of, for instance, a few seconds. In such a case, the corresponding hazard warning devices 12, and thus the alarm devices 18, can be addressed at intermittent intervals during the time that the alarm devices 18 in a particular group are ringing. Each time that the latter are addressed constitutes a new activation impulse for the alarm devices 18, so that it is ensured that the alarms are activated continually during the desired period of time. The activation impulses need to occur with sufficient frequency to prevent the alarm devices (18) from switching off automatically.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

1. A method for controlling a hazard alert system involving a control device (10) and multiple release mechanisms (12) connected to the control device (10), wherein the release mechanisms (12) are each connected to at least one alarm device (18), comprising the steps of:
as an initialisation step, identification data is assigned to the release mechanisms (12);
a control signal for activating or deactivating the alarm devices (18) is transmitted by the control device (10) to all the release mechanisms (12), wherein identification data of one or more release mechanisms (12) is transmitted by means of the control signal;
and the identification data transmitted by the control device (10) is compared by the release mechanisms (12) with the respective identification data assigned to them;
if the release mechanisms (12) determine that the sets of identification data compared with one another match, they transmit a control signal for activating or deactivating the alarm devices (18) connected to them, so that the alarm devices (18) to be activated or deactivated are activated or deactivated synchronously.

2. The method according to claim 1, characterised in that the acoustic signal for activating or deactivating the alarm devices (18) can be transmitted by the control device (10) to all the release mechanisms (12) periodically.

3. The method according to claim 1, characterised in that the control signal for activating or deactivating the alarm devices (18) is transmitted to the release mechanisms (12) by the control device (10), if at least one release mechanism (12) has previously sent out a danger signal to the control device (10).

4. The method according to claim 1, characterised in that the control device (10) transmits the identification data to at least those release mechanisms (12) that have previously sent out a danger signal to the control device (10) by means of the control signal for activating or deactivating the alarm devices (18).

5. The method according to claim 1, characterised in that a communication address clearly identifying each of the respective release mechanisms (12) is assigned to the release mechanisms (12) as identification data.

6. The method according to claim 1, characterised in that multiple groups of release mechanisms (12) are formed, wherein a common respective communication address is assigned to the release mechanisms (12) in a group as identification data.

7. The method according to claim 1, characterised in that the release mechanisms (12) are connected in series to a control line (14) of the control device (10).

8. The method according to claim 1, characterised in that electric power is also supplied to the release mechanisms (12) via the control line.

9. The method according to claim 1, characterised in that the release mechanisms (12) are hazard warning devices (12).

10. The method according to claim 9, characterised in that the hazard warning devices (12) are fire alarms, in particular smoke detectors.

11. The method according to claim 1, characterised in that the alarm devices (18) are visual and/or acoustic alarm devices (18).

12. The method according to claim 1, characterised in that the control device (10) is a fire alarm system control panel (10).

13. A hazard alert system comprising:
a control device (10) and multiple release mechanisms (12) connected to the control device (10) via a control line (14), which, in turn, are each connected to at least one alarm device (18), wherein the release mechanisms (12) each have a storage device, in which the identification data assigned to the respective release mechanisms (12) is stored, wherein the control device (10) has a transmitter, via which a control signal for activating or deactivating the alarm devices (18) can be transmitted to all the release mechanisms (12), wherein identification data of one or more release mechanisms can be transmitted with the control signal, and wherein the release mechanisms (12) each have a comparing device, which is designed to compare the identification data sent out by the control device (10) with the respective identification data deposited in the storage device, and wherein, if the identification data compared by the latter matches, the release mechanisms (12) are designed to transmit a control signal to activate or deactivate the alarm devices (18) to which they are connected, so that the alarm devices (18) to be activated or deactivated are activated or deactivated synchronously.

14. The hazard alert system according to claim 13, characterised in that the control device (10) includes a receiver, which is designed to receive a danger signal emitted by the release mechanisms (12).

15. The hazard alert system according to claim 13, characterised in that a communication address clearly identifying each of the respective release mechanisms (12) is assigned to the release mechanisms (12) as identification data.

16. The hazard alert system according to claim 13, characterised in that multiple groups of release mechanisms (12) are formed, wherein a common respective communication address is assigned to the release mechanisms (12) in a group as identification data.

17. The hazard alert system according to claim 13, characterised in that the release mechanisms (12) are connected in series with the control line (14).

18. The hazard alert system according to claim 13, characterised in that electric power is also supplied to the release mechanisms (12) via the control line (14).

19. The hazard alert system according to claim 13, characterised in that the release mechanisms (12) are hazard warning devices (12).

20. The hazard alert system according to claim 19, characterised in that the hazard warning devices (12) are fire alarms, in particular smoke detectors.

21. The hazard alert system according to claim 13, characterised in that the alarm devices (18) are visual and/or acoustic alarm devices (18).

22. The hazard alert system according to claim 13, characterised in that the control device (10) is a fire alarm system control panel (10).
